(19) United States
(12) Patent Application Publication
(10) Pub. No.: US 2013/0056972 A1
(43) Pub. Date: Mar. 7, 2013

(54) SECURITY ELEMENT HAVING LIGHT-CONDUCTING STRUCTURES

(71) Applicants: Matthias Muller, Bechtsrieth (DE); Gottfried Brandstetter, Grein (AT); Jurgen Keplinger, Saxen (AT); Marco Mayrhofer, Sierning (AT); Martin Bergsmann, Linz (AT); Klaus Schmidegg, Linz (AT); Stephan Trassl, Saxen (AT)

(72) Inventors: Matthias Muller, Bechtsrieth (DE); Gottfried Brandstetter, Grein (AT); Jurgen Keplinger, Saxen (AT); Marco Mayrhofer, Sierning (AT); Martin Bergsmann, Linz (AT); Klaus Schmidegg, Linz (AT); Stephan Trassl, Saxen (AT)

(21) Appl. No.: 13/638,994

(22) PCT Filed: Apr. 28, 2011
(86) PCT No.: PCT/EP11/02119

§ 371 Date: Nov. 19, 2012

(30) Foreign Application Priority Data
May 26, 2010 (AT) A859/2010

(51) Int. Cl. B42D 15/00

(52) U.S. Cl. 283/85

(57) ABSTRACT

The invention relates to a security element having a carrier substrate, at least one surface layer and a waveguide layer, characterized in that the waveguide layer has at least one area in which light is guided both laterally and vertically.

The invention relates to an optical security element which, when excited by light, can be detected visually or by a machine, the location in which the light is coupled in and out not being identical.

Security elements, in particular strip-like or thread-like security elements but also security elements of other formats, are frequently provided with visually detectable security features which exhibit defined optical characteristics.

Security features of this type are, for example, optically active structures such as diffraction gratings, diffraction structures, surface reliefs, kinegrams and the like, and in particular also holograms, in which only under specific reflection conditions is it possible for defined structures, images, lines, symbols, letters, numbers, logos and the like impressed into a varnish layer to be detected visually in a characteristic way.

Likewise, for example from EP-A 0 330 733, security elements having luminescent features are known which become detectable when excited by light of a defined wavelength (e.g. UV or IR radiation). The presence of such a feature can be detected with simple aids such as a UV lamp, even in daily dealings with documents of value.

Furthermore, for example from EP-A 1 558 449, optically variable security features are known which, by means of a specific structure of reflective layers, intermediate layers and, for example, metallic layers, cause different color impressions at different viewing angles. The color change, which usually takes place at a defined angle, can be verified without further aids.

The factor common to all these security features is that the location at which light strikes the security feature, that is to say is coupled in, is also simultaneously the location at which the optical effect is generated, that is to say the light is coupled out. Optically active features such as holograms or optically variable elements are in this case visible at the points at which the light directly strikes the security feature, that is to say for example in the case of a banknote having a window thread, at the points at which the thread is not covered with paper, or on the surface of a security element which is applied to a valuable document. If, for example, a security thread which contains fluorescent features is excited locally with light of suitable wavelength (e.g. in the ultraviolet or infrared spectral range), the fluorescent effect is visible, for example as a result of the emission of visible light, exactly at the point at which the exciting radiation is incident.

WO 2004/062942 discloses a security feature comprising a transparent layer which has a suitable refractive index and a suitable thickness in order to function as a waveguide and which has at least one photoluminescent component over the entire area. At least one surface of the waveguide layer is finished with a pattern which suppresses the waveguiding action in this area and permits the light to emerge at the surface. If, then, light is coupled into the waveguide, for example on the side of the valuable document, the pattern becomes visible.

WO 03/059643 discloses a diffractive security element which is divided into two subareas, which has an optically active structure at interfaces embedded between two layers of a layer composite made of plastic. Here, at least the base layer of the layer composite that is to be illuminated is transparent. The optically active structure has, as base structure, a diffraction grating of the zeroth order with a period length of at most 500 nm. In at least one of the subareas, an integrated optical waveguide having a defined layer thickness and made of a transparent dielectric is embedded between a base layer and an adhesive layer of the layer composite, the profile depth of the optically active structure having a predefined relationship with the layer thickness. When illuminated with white incident light, the security element generates diffracted light in the zeroth order of diffraction.

EP 0 047 326 A1 discloses an identity card which contains information in holographic form. The identity card is constructed in layers and comprises a substrate on which a planar optical waveguide and a photosensitive layer are applied. The photosensitive layer is used to record a plurality of holograms and comprises at least one optical coupler. By means of combination of the light conducted in the waveguide and an incident light beam, exposure of the hologram is carried out, which can then be read again only when the coupler is illuminated with the associated pattern.

WO 2006/056089 discloses a security document in which a light source is provided and also a light-processing device in the form of a hologram which processes the light from the light source in that it deflects, reflects, polarizes and/or partly absorbs said light.

DE 10 2008 033716 discloses a valuable document or security document comprising a document body having an upper side, in the document body a light-conducting structure for conducting light in one plane, which extends substantially parallel to the upper side, being formed via total reflections at interfaces of the light-conducting structure, the interfaces having local modifications so that, at points of the local modifications, coupling of light conducted in the light-conducting structure out of the light-conducting structure is promoted, which leads to emission of light through the upper side of the document body.

It was an object of the invention to provide a security element in which the location of the excitation and the occurrence of an optical effect are different from each other and which has increased security against forgery as compared with the prior art.

The subject of the invention is therefore a security element having a carrier substrate, at least one surface layer and a waveguide layer, characterized in that the waveguide layer has at least one area in which light is guided both laterally and vertically.

Three layers (surface—core—surface) form the basic structure of a waveguide. In order to be able to conduct light, it is necessary that the refractive index of the surface layers is lower than that of the core layer. If, in such a structure, light is injected into the core layer approximately parallel to the interfaces (e.g. via an exposed side edge), then the light beam is reflected totally at the interfaces between core and surface because of the shallow angle of incidence and is thus transported in the core layer. Glass fiber cables, which are used for data transmission nowadays, function in accordance with the same principle.

The invention will be explained in more detail by using the figures.

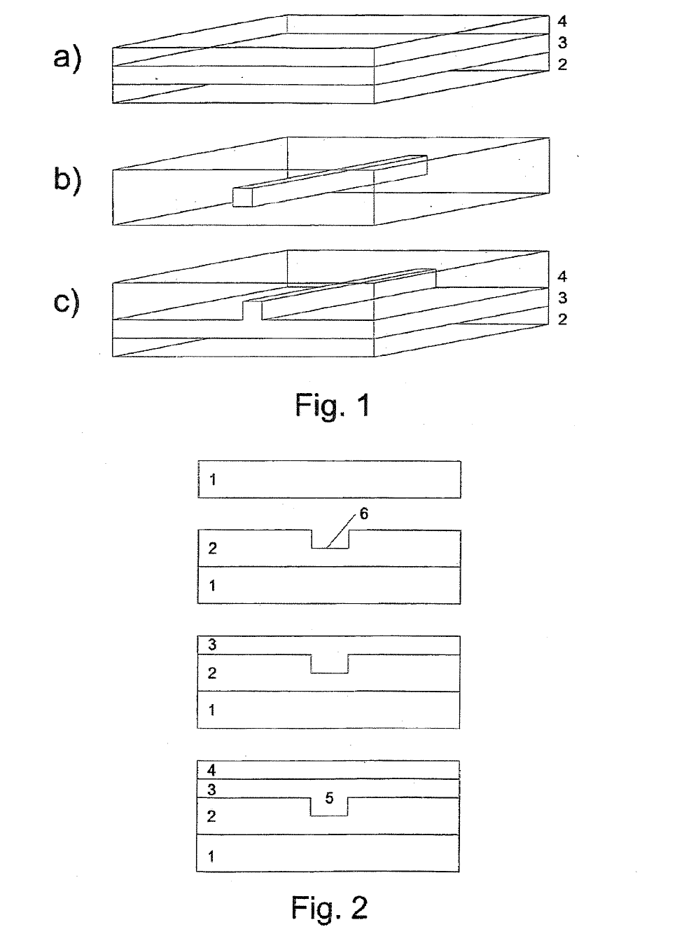

FIGS. 1 and 2 show the basic structure of the security element.

If the waveguide layer extends over the entire area of the substrate, then one speaks of a layer waveguide (FIG. 1a), in which the light can propagate to the same extent in all directions in the plane of the waveguide layer. By means of structuring the waveguide layer 3, one or both surface layers 2, 4, it is moreover possible to achieve the situation where the light is also guided laterally in the plane of the waveguide layer, which means that the light propagation laterally is likewise restricted. The lateral guidance of the light in this case takes place to the same extent via total reflections on the side walls of the ridge which results from the refractive index contrast with respect to the medium surrounding on all sides (FIG. 1b). If, for example because of fabrication conditions, it is not possible to produce a completely encapsulated ridge but lateral guidance of the light is nevertheless to be achieved, it is possible to combine the two above cases, as depicted in FIG. 1c), so that the ridge waveguide rests on the waveguide layer, so to speak. In this case, the light is in principle able to propagate in the entire plane; in the case of targeted injection into the area of the applied ridge waveguide, however, the light is primarily guided both laterally and vertically in the area of the ridge waveguide. The losses then depend to a great extent on the ratio of the ridge thickness to the thickness of the remaining waveguide layer. The thinner the waveguide layer outside the ridge, the better the lateral guidance of the light in the area of the ridge.

The production of such a ridge waveguide is illustrated in cross section in FIG. 2. In a first step, a surface layer 2 is applied to a carrier substrate 1 and provided with an embossing 6, for example in the form of depressions. The waveguide layer 3 is then applied to this structure, the embossing produced in the previous step is filled in again and thus the ridge waveguide 5 is formed. The waveguide is completed by the surface layer 4, if appropriate, which reduces losses of the light upward. Instead of the surface layer, the waveguide layer can also be embossed, as shown in FIG. 1c.

According to the invention, however, at least one of the surface layers or else both surface layers can also be formed by a carrier substrate.

The embossing 6 in the example of FIG. 2 is used to produce the actual ridge waveguide. The cross section of the ridge waveguide can be formed, for example, circularly, rectangularly, trapezoidally or else with another shape, depending upon the requirement.

Given a suitable design of the embossing, various other functions, for example diffractive, diffusely scattering or deflecting functions, can also be implemented.

A particularly beneficial form of the embossing is what is known as a grating coupler. A grating coupler firstly has the task of deflecting light incident from outside through the upper surface layer or through the substrate and the lower surface layer in such a way that said light is able to propagate in the waveguide. However, a grating coupler also functions in exactly the same way in the reverse direction, i.e. light guided in the waveguide can be deflected out of the plane of the waveguide again by means of a grating coupler and thus made accessible to the viewer. The grating has fine structures, the structure size of which lies in the region of the wavelength of the light to be conducted, that is to say in the range from 200-2000 nm.

The grating can have a periodic structure, for example. It can also be composed of a plurality of subareas having different periodic structures or having locally varied periodic structures.

Macroscopically, the active area of the grating can be configured, for example, in the form of lines, arcs, symbols, characters, geometric figures etc. If the grating is used for output coupling, this macroscopic structure is visible to the viewer when the security element is verified.

If appropriate, an additional layer having a refractive index which is higher than that of the waveguide layer can be situated between the embossing of the surface layer and the waveguide layer. This can be necessary, for example, in order to increase the efficiency of a grating coupler and to increase the amount of light which is coupled into and/or out of the optical conductor. This layer having a higher refractive index can firstly be composed of a varnish or polymer, a varnish or polymer with inorganic, highly refractive pigments (for example of TiO₂ or ZrO₂), or of an inorganic high-refractive-index (HRI) layer. The layer having a higher refractive index is preferably composed of metal oxides or sulfides, for example of TiOₓ, SiO, ZrO₂, ZnS.

Suitable as a carrier substrate for the security element according to the invention are, for example, carrier films, preferably flexible plastic films, for example of PI, PP, MOPP, PE, PPS, PEEK, PEK, PEI, PSU, PAEK, LCP, PEN, PBT, PET, PA, PC, COC, POM, ABS, PVC, PTFE, ETFE (ethylene tetrafluoroethylene), PFA (tetrafluoroethylene-perfluoropropyl vinyl ether fluorocopolymer), MFA (tetrafluoromethylene-perfluoropropyl vinyl ether fluorocopolymer), PTFE (polytetrafluoroethylene), PVF (polyvinyl fluoride), PVDF (polyvinylidene fluoride) and EFEP (ethylene-tetrafluoroethylene-hexafluoropropylene fluoroterpolymer).

If appropriate, first of all a first surface layer is applied to the carrier film. This layer must primarily have a very smooth surface in order, in the finished waveguide, to avoid as far as possible losses as a result of scattering at a roughness or waviness of the interfaces. The refractive index of the surface layer must be coordinated with the refractive index of the core layer.

The surface layer is composed of a material which, as compared with the waveguide layer, has a lower refractive index. The absolute refractive index of the surface layer is of secondary importance but preferably lies in the range from 1.3-2.0, particularly preferably in the range from 1.4-1.7.

In principle, all materials which satisfy the above requirements with regard to surface quality and refractive index are suitable for this layer. In order to produce ridge waveguides, however, the ability to process the material in a subsequent embossing process must also be ensured, which is best given by thermoplastic varnish systems and a subsequent hot embossing process or via radiation-curable varnish systems and a subsequent UV embossing process. A suitable UV embossing process and suitable varnish systems are described, for example, in EP-A 1 310 381, a suitable hot embossing process and varnish systems suitable therefor are described, for example, in EP-A 1 352 732.

Thus, suitable for the embossed surface layer 2 and, if appropriate, the second surface layer 4 are, for example, radiation-curable varnish systems based on a polyester system, an epoxy system or polyurethane system, which can contain one or more photoinitiators which, if appropriate, are also able to initiate curing of the varnish system to a different extent at different wavelengths.

The thickness of the surface layers preferably lies in the range from 1-100 μm, particularly preferably in the range from 1-10 μm.

As a result of the embedded waveguide layer or waveguide structure, it is possible to deflect the light in the security element in such a way that it emerges again at a point in the security element that is different from the entry point.

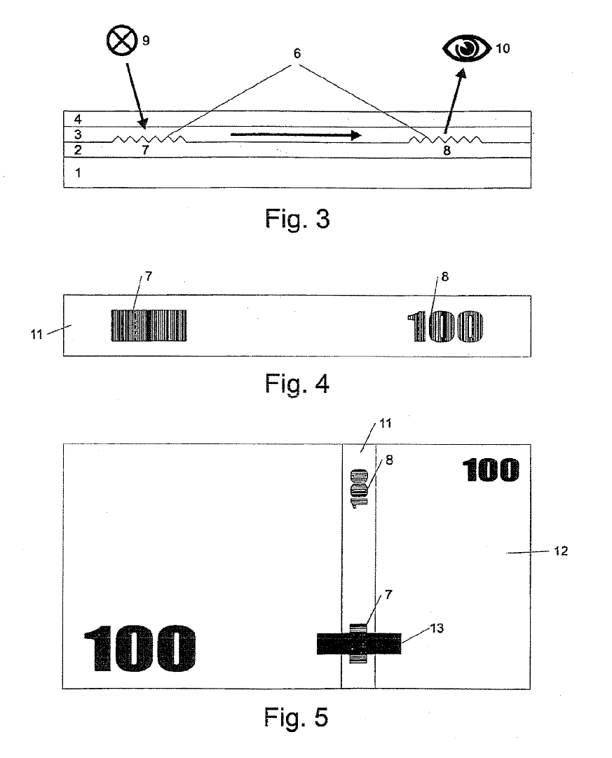

FIG. 3 shows the cross section of an exemplary embodiment of the security element according to the invention which has the above-described waveguide structure, comprising substrate 1, lower surface layer with embossings 6, waveguide layer 3 and upper surface layer 4. The embossings form a coupling-in grating coupler 7 and a coupling-out grating coupler 8 at mutually different locations. The lamp 9 emits light of a specific wavelength, for example, which lies in the visible spectral range. This light is then coupled into the waveguide layer 3 via the grating coupler 7, is guided therein (arrow) and coupled out via the grating coupler 8 such that a viewer 10 perceives the macroscopic structure of the grating coupler 8 in the color of the light emitted by the lamp 9, as shown in plan view in FIG. 4. The macroscopic structure shows the number “100” in the case of the example in FIG. 4 and, for example, can represent the denomination of a banknote in which the security element is embedded or to which the security element 11 is applied.

FIG. 5 shows an embodiment in which the security element 11 is applied to the surface of a banknote 12 and in which the grating coupler 7 is overprinted with a printing ink 13 which has the properties of a color filter. If the banknote 12 is illuminated with polychromatic (e.g. white) light at the location of the grating coupler 7, the light firstly passes through the color filter 13, so that only a specific spectral range of the incident light (e.g. red light) reaches the grating coupler. The light with reduced spectrum is then guided in the waveguide and the number “100” in the region of the grating coupler 8 lights up in the corresponding color (e.g. red). It is conceivable that the color filter is designed in such a way that the resultant color corresponds exactly to the basic color of the banknote (e.g. red) and thus a unique assignment of the feature to the value of the respective banknote is possible. This effect can also be verified quickly by lay persons by using a simple aid (lamp). The color filter effect can also be achieved by the grating coupler itself if the latter, by means of specific design, filters a limited wavelength range out of incident polychromatic light.

It is also possible to couple in white light and, upon emergence, to filter the light via a grating or color filter.

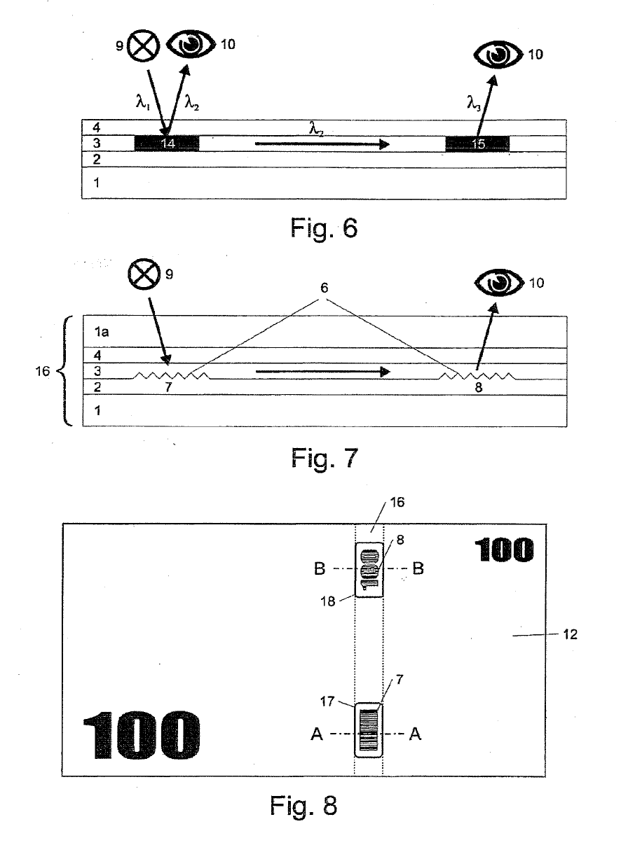

In a further embodiment, which is shown in FIG. 6, instead of the grating couplers, locally fluorescent elements (14, 15) are integrated in the waveguide layer. If the fluorescent element 14 is then excited by light with a wavelength λ₁, the fluorescent element emits light with the wavelength λ₂. Depending on the material used, λ₂ can be larger or smaller than λ₁. The emitted light is then guided within the waveguide structure and strikes the fluorescent element 15, which is in turn excited to fluoresce by λ₂ and emits light with a wavelength λ₃, which is visible to the viewer 10. Since the upper surface layer is generally composed of a transparent material, the fluorescence of the fluorescent element 14 (λ₂) is also visible at the same time. Given an appropriate design, it is even conceivable that local excitation of the fluorescent element 15 with λ₁ leads to no fluorescence, by which means the security can be increased once more. The fluorescent material used in the region 14 and 15 can be both up-conversion (λ₂>λ₁) and down-conversion (λ₂<λ₁) materials. It is also possible to use fluorescent material which, when excited with different wavelengths, exhibits different fluorescences, in which case for example one of these fluorescences in the coupling-out region does not excite any further fluorescence of the element 15 but the other fluorescence does show a fluorescent effect.

The fluorescent elements can either be produced directly during application of the waveguide layer, for example by means of printing an appropriate ink, or subsequently by overprinting or imprinting at defined positions.

Instead of fluorescent elements, scattering elements (pigments, powders, glass beads, etc.) can also be introduced locally into the waveguide layer, for example by imprinting or overprinting, and thus make the light guided in the waveguide visible to the viewer. However, the efficiency of these scattering centers is lower than that of specifically prepared grating couplers and the scattering takes place diffusely.

The aforementioned possibilities for coupling in and out can be combined as desired, depending on the embodiment.

In principle, it can be assumed that the light can also be conducted in the opposite direction in all the embodiments described.

Security features are normally present in the form of threads or strips, which means that one side (parallel to the running direction) is considerably longer than the second. Advantageously, the waveguide regions are therefore present in the longitudinal direction of the security feature, although other orientations at any desired angle with respect to the longitudinal direction are also possible. The more the wavelength region is oriented in the longitudinal direction of the security feature, the greater the possible maximum distance between entry and exit location of the light. The design can be chosen, for example, such that the light spans precisely one length or width of the valuable document.

In the case of a security thread embedded in a substrate, for example a banknote, the incident light can also be coupled out or in via the lateral edge of the thread, if the thread is exposed at at least one lateral edge of the paper.

In a preferred embodiment, the coupling out can take place on both sides of the valuable document. This will be achieved either by means of an individual grating coupler which deflects the light to both sides, or by means of two grating couplers which are fitted to respectively opposite interfaces of the waveguide layer, or by means of scattering centers or fluorescent elements which are visible through the transparent carrier film(s) (FIG. 10).

In the case of a valuable document with window, through which an embedded security feature is exposed and is visible on both sides of the valuable document, the window area is in particular suitable as an exit area for coupling the light out on both sides.

In this case, the coupling out can be carried out by means of all the methods already mentioned, which can be arranged in the form of letters, characters, symbols, images, lines, logos and the like. The coupling elements are preferably completely or approximately completely transparent in the non-illuminated state.

The waveguide layer is composed of a material which, as compared with the surface layers, has a higher refractive index. The refractive index contrast can lie in the range from 0.001 to 2.0, preferably in the range from 0.01 to 0.5. It is particularly important that the material for the waveguide layer has the lowest possible inherent absorption and scattering as a result of defects (air bubbles, cracks, etc.) or inclusions (dispersed particles, agglomerates, contaminants, etc.), and also forms the smoothest possible interface with the surface layers. The waveguide layer can firstly be composed of highly transparent varnish layers but, in specific cases, also of inorganic layers which, for example, are produced by vapor deposition. These inorganic layers can be, for example, oxides or fluorides of metals, such as for example such compounds of Ta, Zr, Ti, Al, Mg, Ba, Ca or Si and the like.

Furthermore, the waveguide varnish can be a highly refractive varnish.

Furthermore, suitable varnish systems are those systems in which the binder is completely dissolved and are therefore highly transparent and can be constituted in pure form. Examples of such varnish systems are known to those skilled in the art; particularly suitable, amongst others, are also soluble varnish systems based on polyester or nitrocellulose and the like.

In a further embodiment, the ridge waveguide can be formed by a local modification of the refractive index. Such local modifications can be made, for example, by laser treatment, electron-beam or UV exposure. However, it is also possible to achieve the local modification by means of chemical gas-phase reaction.

The photochemical reaction of thiocyanates to form isothiocyanates is used for the surface modification of polymers.

For instance, the UV irradiation (λ=254 nm) of poly(4-vinylbenzothiocyanate-co-styrene) (P(VBT-co-ST)) leads to a change in the refractive index from n=1.616 to n=1.630. This reaction can be attributed to the isomerization of the SCN groups to form NCS groups. The gas-phase reaction with amines (e.g. with propylamine) leads to a further refractive index change and to a change in the layer thickness of the polymer film. As a result of this reaction, the reactive NCS groups are converted to stable thiourea groups.

The absolute refractive index of the waveguide layer is of secondary importance here but preferably lies in the range from 1.5-2.5, particularly preferably in the range from 1.5-1.8.

The layer thickness of the waveguide layer is 0.1-100 μm, preferably 0.1-50 μm, particularly preferably 0.1-10 μm.

Instead of the surface layer, the waveguide layer can also be embossed.

The structure can possibly be laminated against a further carrier substrate la by means of a laminating adhesive. A structure of this type is shown in FIG. 7. The functionality of the security element in this case corresponds substantially to the structure shown in FIG. 3. The laminating adhesive in this embodiment can perform the function either of the waveguide layer 3 or of a surface layer (2 or 4) if the optical properties thereof satisfy the above-mentioned requirements. Otherwise, the laminating adhesive can also be an additional layer in the film structure which, for example, is located between the carrier substrate 1 and the embossed surface layer 2 or between the carrier substrate la and the second surface layer 4. The layer thickness of the laminating adhesive is 1-100 μm, preferably 1-10 μm.

If, on both carrier substrates, there are features or optical elements which are to be aligned with one another, then the joining of the two carrier substrates can be carried out by means of an accurate-register laminating process. A suitable method is described in EP-A 1 318 016.

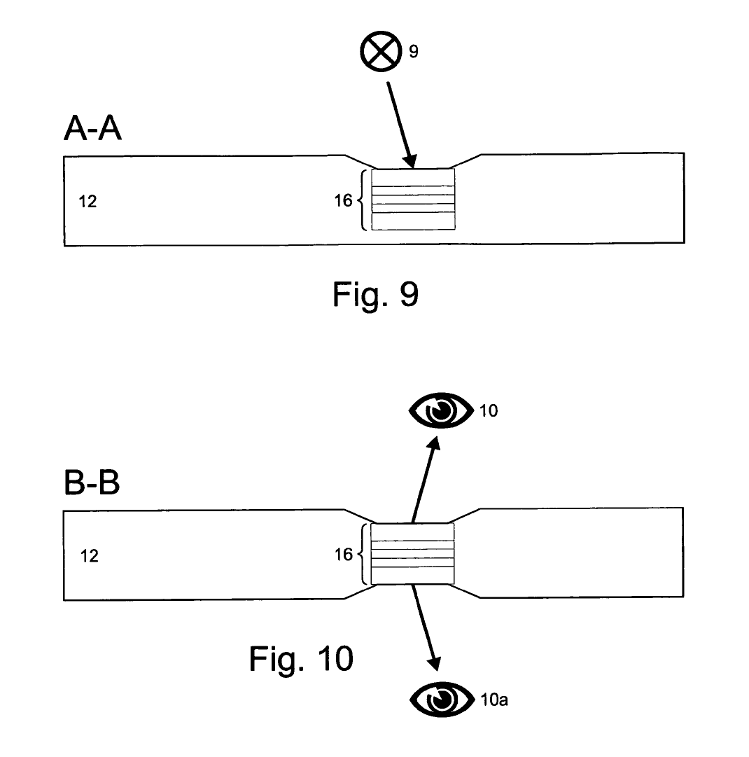

FIG. 8 shows the plan view of a valuable document in which a security element 16 is partly embedded. Here, the security element is visible in two windows 17, 18 of the valuable document, on the surface of the latter. In the window 17 there is a grating coupler in the form of a rectangle, via which light can be coupled into the security element. In the window 18 it is possible to see a second grating coupler 8 in the form of a line of text “100”, via which the light is coupled out again. The cross-sectional view of the valuable document in the area of the window 17 is shown in FIG. 9. The security element is free on one side in this window, i.e. the security element is not covered by paper fibers on the exposed side. On this side, light can be coupled in by using a light source 9. In the area of the window 18, the security element is exposed on both sides, as shown in FIG. 10. This means that a viewer can look directly at the security element from both sides in this area. If, then, light is coupled in via the grating coupler 7 in the window 17 and, within the security element, is led via the ridge waveguide 5 to the grating coupler 8 in window 18, then the emergent light can be seen by a viewer on both sides of the valuable document (10 and 10a, respectively). However, in the non-illuminated state, the window appears virtually completely transparent on account of the high transparency of the core and surface layers and the suitable coordination of the refractive indices.

In the embodiment according to the invention shown in FIGS. 8 to 10, the security feature is introduced into the substrate in accurate register with respect to the windows, so that the coupling-in and coupling-out regions always come to lie in the area of the window. Such a method is described, for example, in WO 2004/050991.

In a further embodiment, a plurality of waveguides can be arranged parallel to one another or be located in different planes of the security element and appear again at different locations (e.g. in different windows). FIG. 11 shows such an embodiment of the security element according to the invention, here, instead of a single ridge waveguide 5, two separate ridge waveguides 5a and 5b being introduced into the security element. The two ridge waveguides conduct the light from the coupling-in area 7 to different coupling-out areas 8a and 8b, which are each located in different windows (18 and 19) of the valuable document. If the coupling-in area 7 is then illuminated, the light becomes visible to a viewer both in the area 8a and in the area 8b, and thus generates an amazing optical effect which can be verified simply.

If there is a plurality of waveguides, individual waveguides can be deactivated subsequently, for example by means of lasers, mechanically or chemically, by means of local hindering of the waveguiding action, and the light as it emerges can be made to appear as a code in the form of images, symbols, characters, letters, lines, codes.

In a preferred embodiment, this coding can, for example, be implemented individually for each individual valuable document. Such an embodiment is shown in FIG. 12 by using the example of a security element having three ridge waveguides (5a, 5b, 5c), which conduct the light coupled in in the region 7 to the coupling-out regions 8a, 8b and 8c. The ridge waveguide 5c has been interrupted in FIG. 12 by means of irradiation with a laser beam, which melts the polymer material and thus leads to a local interruption of the light conduction. If light is then coupled in in the region 7, the light will be visible to a viewer only in the regions 8a and 8b but the region 8c remains dark.

The security element according to the invention can have further functional layers.

The functional layers can, for example, have defined magnetic, chemical, physical and also optical or optically active properties.

In order to adjust the magnetic properties, paramagnetic, diamagnetic and also ferromagnetic substances, such as iron, nickel and cobalt or compounds thereof or salts thereof (for example oxides or sulfides), can be used.

Particularly suitable are magnetic pigment colors having pigments based on Fe oxides, iron, nickel, cobalt and alloys thereof, barium or cobalt ferrites, hard- and soft-magnetic iron and steel grades in aqueous or solvent-containing dispersions. Suitable solvents are, for example, i-propanol, ethyl acetate, methyl ethyl ketone, methoxypropanol and mixtures thereof.

The pigments are preferably introduced into acrylate polymer dispersions having a molecular weight from 150,000 to 300,000, into, nitrocellulose, acrylate-urethane dispersions, acrylate-, styrene- or PVC-containing dispersions or into solvent-containing dispersions of this type.

The optical properties of the layer can be influenced by means of visible dyes or pigments, luminescent dyes or pigments, which fluoresce or phosphoresce in the visible region, in the UV region or in the IR region, effect pigments, such as liquid crystals, pearl essence, bronzes and/or multilayer color-change pigments and heat-sensitive inks or pigments. These can be used in all possible combinations. In addition, phosphorescent pigments can also be used on their own or in combination with other dyes and/or pigments.

It is also possible for various properties to be combined by adding a variety of the above-mentioned additives. It is possible to use dyed and/or conductive magnetic pigments, for example. All the aforementioned conductive additives can be used here.

In particular in order to dye magnetic pigments, all known soluble and insoluble dyes or pigments can be used. For example, a brown magnetic ink can be made metallic in hue, for example silvery, by the addition of metals.

In order to adjust electrical properties, for example conductivity, it is possible to add, for example, graphite, carbon black, conductive organic or inorganic polymers, metal pigments (for example, copper, aluminum, silver, gold, iron, chromium and the like), metal alloys such as copper-zinc or copper-aluminum or else amorphous or crystalline ceramic pigments such as ITO and the like. Furthermore, doped or non-doped semiconductors such as, for example, silicon, germanium or ion conductors such as amorphous or crystalline metal oxides or metal sulfides can be used as an additive. Furthermore, in order to adjust the electrical properties of the layer, polar or partially polar compounds such as surfactants, or non-polar compounds such as silicone additives or hygroscopic or non-hygroscopic salts, can be used or added.

Furthermore, the security element according to the invention can also have features with optically active properties, such as diffractive structures, diffraction gratings, holograms, surface reliefs and the like.

In order to anchor the security element in or on the valuable document, the former is usually provided with an adhesive coating. This adhesive coating can be implemented either in the form of a heat-seal, cold-seal or self-adhesive coating. The adhesive can also be pigmented, it being possible for the pigments used to be all known pigments or dyes, for example TiO₂, ZnS, kaolin, ATO, FTO, aluminum, chromium oxides and silicon oxides or, for example, organic pigments such as phthalocyanine blue, i-indolide yellow, dioxazine violet and the like. Furthermore, it is possible to add luminescent dyes or pigments which fluoresce or phosphoresce in the visible region, in the UV region or in the IR region, effect pigments such as liquid crystals, pearl essence, bronzes and/or multilayer color-change pigments and heat-sensitive inks or pigments. These can be used in all possible combinations. In addition, luminescent pigments can also be used on their own or in combination with other dyes and/or pigments.

The adhesive layer can be applied over the entire area or partially; the adhesive layer is preferably cut out in the area of the coupling-in and coupling-out structures.

If appropriate, the security element can also be protected further by a protective varnish layer, which can be pigmented or non-pigmented, and can be applied over the entire area or partially and is likewise preferably cut out in the area of the coupling-in and coupling-out structures.

The security elements and the film material are therefore suitable, if appropriate following appropriate tailoring, as security features in data storage media, in particular in valuable documents such as identity cards, cards, bank notes or labels, seals and the like, but also as packaging material, for example in the pharmaceutical, electronics and/or foodstuffs industries, for example as blister films, folded boxes, coverings, film packs and the like.

For the application as security features, the substrates are preferably cut into strips, threads or patches, it being possible for the width of the strips or threads preferably to be 0.5-20 mm and for the patches preferably to have average widths and lengths of 1-50 mm.

In a further embodiment, the security element can be designed as a transfer element, the carrier substrate being pulled off following the application to the object to be secured. If appropriate, the release capability can in this case be set by a known release layer applied to the carrier substrate.

Suitable as a release layer are known poorly adhering compositions, for example based on cycloolefin copolymers, nitrocellulose, acrylates, polyvinyl chloride, ethylene acrylate copolymers or styrene acrylates in a suitable solvent. In order to adjust the adhesion, chlorinated polyolefins are preferably added. Furthermore, it is also possible to use polyamide, polyethylene, fluoropolymer wax layers or silicone coatings applied very thinly as a release layer.

Such an embodiment is shown in FIG. 13, the carrier substrate 1 being pulled off following the application of the security element to the valuable document 12, and the remaining layer structure having the surface layers 2 and 4 and also the waveguide layer 3 and the adhesive layer 21 remaining on the valuable document 12. In this embodiment, the surface layer 2 is produced in such a way that, although the adhesion thereof to the carrier substrate 1 is adequate for the processing of the security element, detachment during the application to the valuable document 12 is possible without any additional release layer if the adhesive force of the adhesive layer 21 on the valuable document and the adhesions of the remaining layers to one another are great enough. The layers are so thin that, in the event of a manipulation, the attempt to detach the layers from the valuable document again leads with great certainty to destruction of the waveguide function.

1. A security element having a carrier substrate, at least one surface layer and a waveguide layer, characterized in that the waveguide layer has at least one area in which light is guided both laterally and vertically.

2. The security element as claimed in claim 1, characterized in that the carrier substrate forms a surface layer.

3. The security element as claimed in claim 1, characterized in that a second surface layer is formed by a varnish layer or a further carrier substrate.

4. The security element as claimed in claim 1, characterized in that the waveguide layer is a varnish layer which has a higher refractive index than the surface layer(s).

5. The security element as claimed in claim 1, characterized in that the surface layer(s) are composed of the same material.

6. The security element as claimed in claim 1, characterized in that the surface layer (s) are composed of different materials.

7. The security element as claimed in claim 1, characterized in that an HRI layer is additionally contained in the structure.

8. The security element as claimed in claim 1, characterized in that the light is coupled in or out via at least one side edge.

9. The security element as claimed in claim 1, characterized in that the light is coupled in and/or out at at least one point on the upper side and/or underside of the security element.

10. The security element as claimed in claim 1, characterized in that the lateral and vertical guidance of the light is achieved by means of a ridge waveguide.

11. The security element as claimed in claim 10, characterized in that the ridge waveguide is formed by an embossing in one of the surface layers or in the waveguide layer.

12. The security element as claimed in claim 10, characterized in that the ridge waveguide is formed by a local modification of the refractive index of the waveguide layer.

13. The security element as claimed in claim 12, characterized in that the local modification is produced by laser, electron-beam or UV exposure or by chemical gas-phase reaction.

14. The security element as claimed in claim 1, characterized in that, at least in one region, the coupling in and out is carried out by an embossing in the form of a grating coupler.

15. The security element as claimed in claim 1, characterized in that, at least in one region, the coupling in and out is carried out by an embossing in the form of a diffractive or diffusely scattering structure.

16. The security element as claimed in claim 1, characterized in that a region having luminescent or scattering elements is provided in one of the surface layers or in the waveguide layer.

17. The security element as claimed in claim 14, characterized in that the embossing or the regions having fluorescent or scattering elements are present in the form of letters, characters, symbols, codes.

18. The security element as claimed in claim 1, characterized in that the security element is laminated against a second carrier substrate by means of a laminating adhesive.

19. The security element as claimed in claim 18, characterized in that the laminating adhesive functions as a waveguide layer or one of the surface layers.

20. The security element as claimed in claim 1, characterized in that it is provided with an adhesive coating over the entire area or partially, at least on one side.

21. The security element as claimed in claim 19, characterized in that the adhesive coating is a heat-seal, cold-seal or self-adhesive coating.

22. The security element as claimed in claim 1, characterized in that it is provided with a whole-area or partial protective varnish layer on one or both sides.

23. The security element as claimed in claim 1, characterized in that it is at least partly embedded in a valuable document.

24. The security element as claimed in claim 1, characterized in that it is applied to the surface of a valuable document.

25. The security element as claimed in claim 24, characterized in that the carrier substrate is removed following application to the valuable document.

26. The security element as claims in claim 1, characterized in that it has further functional layers.

27. The security element as claimed in claim 1, characterized in that it is applied to the valuable document in accurate register or is introduced into the valuable document.

28. The security element as claimed in claim 1, characterized in that it is overprinted after the application or embedding.

29. A valuable document containing a security element as claimed in claim 1.
